(19) United States
(12) Patent Application Publication
(10) Pub. No.: US 2022/0107825 A1
(43) Pub. Date: Apr. 7, 2022

(54) Measuring the Memory Usage of Java Programs

(71) Applicant: VMware, Inc., Palo Alto, CA (US)

(72) Inventors: Weiqiang Tang, Beijing (CN); Wenfeng Liu, Beijing (CN); Mengdie Song, Beijing (CN); Donghai Han, Beijing (CN); Wenying Dong, Beijing (CN); Rui Cao, Beijing (CN); Qi Wu, Beijing (CN)

(21) Appl. No.: 16/482,244

(22) PCT Filed: Jul. 11, 2019
(86) PCT No.: PCT/CN2019/095596

§ 371 Date: Oct. 8, 2021

(51) Int. Cl. G06F 9/455; G06F 9/50

(52) U.S. Cl. CPC G06F 9/45504; G06F 2009/45583; G06F 9/5016; G06F 9/45558

(57) ABSTRACT

Techniques for measuring the memory usage of Java programs are provided. In one set of embodiments, a Java agent can detect that a Java Virtual Machine (JVM) is loading a Java class used by a Java program. The Java agent can further determine a class name of the Java class and determine that the class name matches an entry in a first list included in a user-defined configuration file. The Java agent can then dynamically insert bytecode into a constructor of the Java class, where the inserted bytecode includes logic for registering a memory reference to an object created via the constructor.

### BACKGROUND

Measuring or in other words, “profiling” the memory usage of software programs is an important part of the software development process. Among other things, memory profiling enables a user (e.g., developer) to identify the portions of a software program that are consuming the most memory. The user can then attempt to optimize the identified portions in order to improve the software program's overall memory footprint and performance.

For Java programs (i.e., software programs written in the Java programming language), there are a number of existing graphical user interface (GUI)-based memory profiling tools. These tools generally operate by dumping the entire contents of the heap (i.e., the area of Java Virtual Machine (JVM) memory where objects and instance variables are stored) into a file maintained on disk and presenting memory usage statistics for the heap, as determined from the file, in a graphical format. However, there are two issues with this approach. First, because the heap dump file includes the entirety of the heap, this file typically requires a large amount of disk space (approximately equal to the total memory size of the Java program). Second, because the GUI presents memory usage statistics for every single object/variable found in the heap, a user of such a tool must go through the time-consuming process of manually scanning all of the presented information in order to find the particular sections he/she is interested.

In addition to GUI-based tools, there are several currently-available Java libraries that enable users to measure the memory usage of their Java programs. However, these libraries generally require users to add explicit annotations to the program source code in order to configure memory measurement behavior. For example, if a user is interested in measuring the memory usage of a class C1, the user will typically need to add an annotation to the class definition of C1 that indicates memory measurement should be enabled with respect objects created/instantiated. from this class (e.g., “@measure”). Similarly, if the user is not interested in measuring the memory usage of a class C2, the user will typically need to add an annotation to the class definition of C2 that indicates memory measurement should be disabled with respect to objects created/instantiated from this class (e.g., “@unmeter”). This practice of annotating source code on a per-class basis to configure memory measurement behavior is cumbersome and undesirable.

### BRIEF DESCRIPTION OF THE DRAWINGS

FIG. 1 depicts an example workflow for building and running a Java program according to certain embodiments.

FIG. 2 depicts a memory measurement architecture including a memory profiling agent according to certain embodiments.

FIG. 3 depicts a registration phase workflow that may be implemented by the memory profiling agent of FIG. 2 according to certain embodiments.

FIGS. 4A and 4B depict measurement phase workflows that may be executed by the memory profiling agent of FIG. 2 according to certain embodiments.

FIGS. 5A and 5B depict a tree representation of an example object that is measured by the memory profiling agent of FIG. 2 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure are directed to improved techniques for measuring the memory usage of Java programs. At a high level, these techniques involve using a Java agent to dynamically insert bytecode into a compiled Java program at runtime, where the inserted bytecode includes logic for registering memory references to objects that are identified as measurement targets in a configuration file. Upon registering these memory references, the Java agent can measure the memory usage of the objects in a manner that excludes the measurement of certain “banned” fields/sub-objects (also identified in the configuration file). The Java agent can then output the collected memory usage statistics to, e.g., a log file or one or more other storage locations for user review.

With this general approach, users can profile the memory usage of their Java programs with a high degree of granularity and configurability, without requiring any changes to program source code. The foregoing and other aspects of the present disclosure are described in further detail below.

### 2. Example Java Build/Runtime Workflow and Solution Architecture

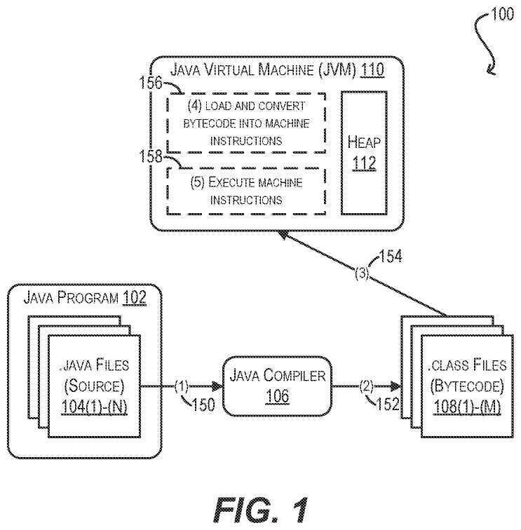

To provide context for the embodiments described herein, FIG. 1 depicts an example workflow 100 for building and running a typical Java program 102. Because Java is an object-oriented programming language, the source code for Java program 102 comprises a collection of class definitions that are organized as one or more “.java” files 104(1)-(N). As used herein, a “class” is a user-defined blueprint or prototype for an object. An “object” is a data structure including both state (in the form of one or more fields) and procedures (in the form of one or more methods) that is created/instantiated from its corresponding class at program runtime. A field of an object can refer to another object (i.e., sub-object), which in turn can refer to yet another sub-object and so on, resulting in a tree-like structure with a given object at its root. Alternatively, a field of an object can correspond to a Java primitive data type that comprises a single value (e.g., a boolean, byte, char, short, int, long, float, or double).

As shown in FIG. 1, at the time of building Java program 102, the source code for program 102 (i.e., .java files 104(1)-(N)) is provided as input to a Java compiler 106 (step (1), reference numeral 150). Java compiler 106 compiles the source code into Java bytecode that is organized as one or more “.class” files 108(1)-(M) (step (2), reference numeral 152). This Java bytecode is low-level, typically binary code that expresses the program logic included in .java files 104(1)-(N) in a format understood by a Java Virtual Machine (JVM) 110.

Then, at the runtime of Java program 102, the bytecode of program 102 (i.e., .class files 108(1)-(M) is provided as input to Arm 110 (step (3), reference numeral 154). JVM 110 loads and converts the bytecode into machine instructions that are native to the computing platform on which the JVM runs (step (4), reference numeral 156). Finally JVM 110 executes the native machine instructions, thereby running Java program 102 (step (5), reference numeral 158).

As part of steps (4) and (5), NM 110 will allocate and store objects that are created from class definitions (as well as instance variables of those objects) in a region of memory shown as heap 112. Heap 112 is typically the largest contributor to the overall memory footprint of a Java program; thus, it is useful to be able to profile heap 112 in order to understand how it allocated/used (and thereby understand how the Java program can be optimized). Unfortunately, as mentioned in the Background section, Java memory profiling tools and libraries that are currently available for this purpose suffer from various limitations. For example, existing GUI-based tools require a large amount of disk space to hold a heap dump file and are not particularly configurable; if a user is only interested in the memory consumed by certain classes/objects, the user must manually scan the entire graphical interface in order to find those classes/objects and their associated statistics. Further, existing Java libraries that provide functions for memory measurement generally require users to add annotations to their source code in order to, e.g., identify the specific classes to be included in or excluded from measurement. This process is burdensome and impractical for development projects involving a large number of source code files and/or requiring a large number of different measurement scenarios.

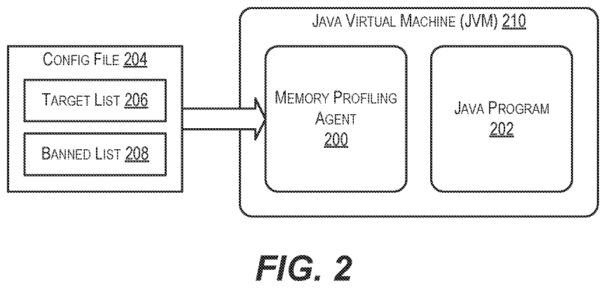

To address the foregoing and other similar issues, FIG. 2 depicts the architecture of a novel memory measurement solution for Java programs according to certain embodiments. As shown in FIG. 2, this solution architecture includes a memory profiling agent 200 that interacts with a target Java program 202 (i.e., a Java program to be profiled). Both memory profiling agent 200 and Java program 202 are loaded into and run within a JVM 210. In a particular set of embodiments, memory profiling agent 200 can be a Java agent that is implemented via the Java instrumentation API. The solution architecture of FIG. 2 further includes a user-defined. configuration file 204 that is accessible by memory profiling agent 200 and includes, among other things, a list of target classes/fields (i.e., “target list”) 206 and a list banned classes/fields (i.e., “banned list”) 208.

As described in further detail below, memory profiling agent 200 can operate according to two phases: a registration phase and a measurement phase. During the registration phase, memory profiling agent 200 can check, at the time the bytecode for a class definition of Java program 202 is loaded by JVM 210, whether the class is identified in target list 206 of configuration file 204. If so, memory profiling agent 200 can dynamically modify the bytecode for the constructor(s) of the class to register a reference to each object created via the constructor(s) of the object. In this way, memory profiling agent 200 can track the memory location of every object of Java program 202 that is deemed a measurement target per configuration file 204.

Then, during the measurement phase, memory profiling agent 200 can retrieve the references registered during the registration phase and can traverse the fields of each registered object to measure their memory usage (and thus determine the overall memory usage of the object). As part of this traversal, memory profiling agent 200 can specifically ignore fields/sub-objects of the target object that are defined in banned list 208 of configuration file 204. In addition, in certain embodiments memory profiling agent 200 can check whether a given field/sub-object has already been measured (due to, e.g., multiple or cyclic references) and if so, can avoid “over-counting” that field/sub-object. Finally, memory profiling agent 200 can write out its measurements to, e.g., a log file or one or more other predefined storage locations, and the measurement phase can be repeated as needed or desired throughout the runtime of Java program 202.

With this memory measurement solution, a number of advantages are achieved over existing approaches. First, this solution is highly configurable because users can define the exact classes/fields they are interested in measuring and/or not interested in measuring via the target and banned lists of configuration file 204. For example, a user may specify that he/she would like to measure all of the fields of class C1 except for fields F1 and F3. This level of measurement configurability is generally not possible with existing profiling libraries.

Second, because the solution of the present disclosure leverages dynamic bytecode modification, there is no need to modify the source code of Java program 202 in order to implement or change memory measurement behavior. Instead, all measurement rules/controls are encapsulated in configuration file 204, which are then applied to the bytecode of Java program 202 by memory profiling agent 200 at program runtime. This means that Java program 202 does not need to be updated and re-compiled when, e.g., measurement targets are added, removed, or modified.

Third, as mentioned above, the solution of the present disclosure can provide more accurate memory measurements by intelligently identifying scenarios where a field/sub-object has already been measured as part of a target object, thereby avoiding over-counting of that field/sub-object.

The following sections provide further details regarding the implementation of configuration file 204 and memory profiling agent 200 according to various embodiments. It should be appreciated that the architecture shown in FIG. 2 is illustrative and not intended to limit embodiments of the present disclosure. For instance, although FIG. 2 depicts a particular arrangement of components, other arrangements are possible (e.g., the functionality attributed to a particular component may be split into multiple components, components may be combined, etc.). Further, the solution architecture may include other components/sub-components and/or implement other functions that are not specifically described. One of ordinary skill in the art will recognize other variations, modifications, and alternatives.

### 3. Configuration File

As indicated above, configuration file 204 of FIG. 2 encodes the memory measurement behavior of memory profiling agent 200 via a target list 206 and a banned list 208. Each of these lists is discussed in turn below.

### 3.1 Target List

Target list 206 identifies the classes and/or class fields of Java program 202 that should be measured by memory profiling agent 200. Accordingly, each entry in target list 206 can include a class name (in, e.g., canonical name format) and optionally one or more fields of that class. The “canonical name” of a Java class is the class' name as specified in its class definition, along with the Java package the class is a part of. For instance, the canonical name of the Java standard “File” class is “java.io.File.”

If only a class name is specified in a target list entry, the entirety of each object that is created from that class can be considered a measurement target. Alternatively, if one or more fields are specified, only those fields/sub-objects of objects created from the class can be considered measurement targets. For example, consider the following example target list:

Listing 1

“targetList”: [

{

“className”: “com.org.Class1”,
“fields”: [

{

“name”: “instanceMap”

},
{

“name”: “initializedInstances”

}

]

},
{

“className”: “com.org.class2”

}

]

In this example, the target list entry corresponding to class name “com.org.class2” does not specify any fields. Thus, the entirety of each object created from class “com.org.class2” (in other words, all the object's fields) will have its memory usage measured by memory profiling agent 200. If any of the object's fields refer to sub-objects, the memory usage of those sub-objects will also be measured and added to the overall memory usage of the “com.org.class2” object.

On the other hand, the target list entry corresponding to class name “com.org.class1” specifies two fields “instanceMap” and “initializedInstances.” Thus, only these fields of objects created from class “com.org.class1” will be measured and other fields will be ignored.

In some embodiments, in addition to specifying a class name and zero or more fields, each target list entry can also specify a measurement mode having one of three possible values: object, map, and auto. If the object measurement mode is specified, memory profiling agent 200 can measure the target object identified in the entry using the standard approach mentioned above (i.e., measure the usage of all target fields of the object). Alternatively, if the map measurement mode is specified, memory profiling agent 200 can assume that the target object is a collection that implements the Java collection or map interface and can (1) measure the overall size of the collection, (2) count the number of elements in the collection, and (3) calculate an average size per element by dividing (1) by (2). This generally provides a more readable and relevant measurement result for such collections than the object measurement mode. Finally, if the auto measurement mode is specified, memory profiling agent 200 can determine whether the object or map mode is appropriate for the target object at runtime of Java program 202 (by, e.g., determining whether the target object is actually a collection or map) and apply the appropriate measurement mode automatically.

3.2 Banned list

Banned list 208 identifies classes and/or class fields of Java program 202 that should not be measured (i.e., ignored) by memory profiling agent 200. Among other things, this allows certain fields/sub-objects of an object O identified as a measurement target via target list 206 to be excluded from the overall measurement of O.

Like target list 206, each entry in ban list 208 can include a class name (in, e.g., canonical name format) and optionally one or more fields of that class. If only a class name is specified, the entirety of each object that is created from that class will be ignored by memory profiling agent 200. Alternatively, if one or more fields are specified, only those fields/sub-objects of objects created from the class will be ignored.

When specifying a class name in a ban list entry, in certain embodiments one of three different formats may be used: “super name,” “prefix name,” and “class name.” With the super name format, memory profiling agent 200 can exclude from measurement any class which is a subclass of the class name provided. With the prefix name format, memory profiling agent 200 can exclude from measurement any class matching the prefix string provided. And with class name format, memory profiling agent 200 can exclude from measurement the particular class identified by the class name provided.

The following is an example ban list that illustrates the concepts above:

Listing 2

“bannedList”: [

{

“superName”: “com.org.class3”

},
{

“prefixName”: “com.org.class4”

},
{

“className”: “com.org.class5”,
“fields”: [

“queue”,
“scheduledExecutor”

]

}

]

### 4. Registration Phase

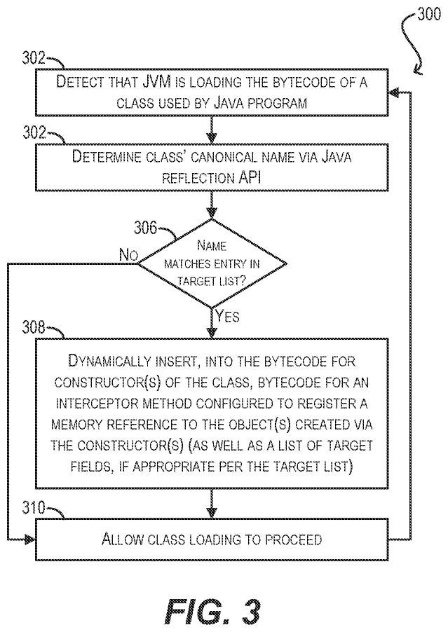

FIG. 3 depicts a workflow 300 that provides additional details regarding the registration phase that can be executed by memory profiling agent 200 of FIG. 2 at the runtime of Java program 202 according to certain embodiments. Workflow 300 assumes that memory profiling agent 200 is loaded into JVM 210 at or near the start of Java program 202′s execution. For example, in one set of embodiments memory profiling agent 200 may be specified as a startup parameter for JVM 210 (using, e.g., the “-javaagent” command line argument) at the time of initiating Java program 202. In other embodiments, Java program 202 may invoke memory profiling agent 200 at the beginning of its main method (via, e.g., an “agent.start( )” call).

At block 302, memory profiling agent 200 can detect that NM 210 is loading (or has loaded) the bytecode for a class used by Java program 202. In response, memory profiling agent 200 can use the Java reflection API to determine the class's canonical name (block 304) and check whether the determined canonical name matches any of the class names specified in the entries of target list 206 of configuration file 204 (block 306).

If the answer is no, memory profiling agent 200 can conclude that objects of this class do not need to be measured/profiled and can proceed to the end of the workflow. On the other hand, if memory profiling agent 200 does find a match between the determined canonical name and a target list entry, memory profiling agent 200 can conclude that objects of this class should be measured/profiled. As a result, memory profiling agent 200 can dynamically insert, into the bytecode for the constructor(s) of the class, bytecode for an interceptor method (block 308). As used herein, a “constructor” for a class is a method that creates/instantiates a new object for the class. In some cases a class may have multiple constructors, in which case memory profiling agent 200 may insert the bytecode for the interceptor method into each of the multiple constructors.

In various embodiments, the interceptor method can register (or in other words, record) a memory reference (i.e., pointer) to the new object created via the class' constructor. in addition, if the matched target list entry specifies one more fields, the interceptor method can record those target fields with the object memory reference.

Finally, once the interceptor method has been inserted into the class' constructor(s), memory profiling agent 200 can allow the class loading process to proceed as normal and workflow 300 can loop back to block 302 for additional class loading events. The end result of this registration phase is that the constructor of every class specified in target list 206 will register (via the inserted interceptor method) a memory reference to the target object created by that constructor (and an associated list of target fields, if appropriate) at the time the constructor is invoked. These memory references can be subsequently used by memory profiling agent 200 during the measurement phase in order to locate the target objects and to measure their memory usage.

### 5. Measurement Phase

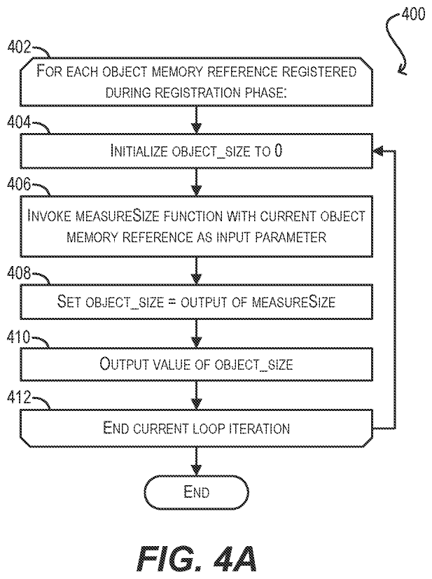

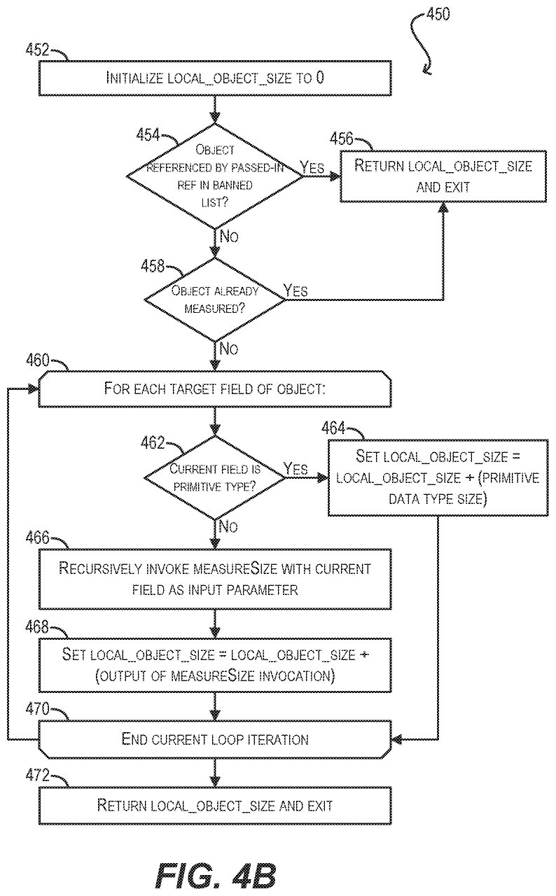

FIGS. 4A and 4B depict workflows 400 and 450 respectively that provide additional details regarding the measurement phase that can be executed by memory profiling agent 200 of FIG. 2 during the runtime of Java program 202 according to certain embodiments. In particular, workflow 400 depicts a high-level process for measuring the memory sizes of target objects registered via the registration phase and workflow 450 depicts a recursive measurement (i.e., “measureSize”) function that can be called within workflow 400 and/or within the function itself to traverse down the object tree/hierarchy of a given target object and measure the memory sizes of sub-objects of that target object (if needed).

In various embodiments, workflows 400 and 450 assume that the measurement phase is requested by, e.g., a user of memory profiling agent 200 at some point after the completion of the registration phase (in other words, after all classes of Java program 202 have been loaded and their constructors have been modified per workflow 300, as appropriate). The user can submit this request via, e.g., a command line interface (CU) command or an invocation of an API exposed by memory profiling agent 200. These workflows also assume that target objects are measured using the “object” measurement mode mentioned in section 3.1.

Starting with block 402 of workflow 400 of FIG. 4A, memory profiling agent 200 can enter a loop for each object memory reference registered via the interceptor method inserted into class constructors per workflow 300 of FIG. 3. Within this loop, memory profiling agent 200 can initialize an “object_size” variable to zero (block 404), invoke the measureSize function with the current object memory reference as an input parameter (block 406), and set object_size to the output of measureSize (block 408).

Memory profiling agent 200 can then output the value of object_size to one or more predefined storage locations (e.g., a log file) (block 410), reach the end of the current loop iteration (block 412), and return to the top of the loop to process additional object memory references. Once all such references have been processed, the workflow can end.

Turning now to the implementation of the measureSize function shown in FIG. 4B, at blocks 452 and 454 memory profiling agent 200 can initialize another object size variable (i.e., “local_object_size”) to zero and can check whether the class name of the object referenced by the passed-in memory reference is identified in banned list 208. If the answer is yes, memory profiling agent 200 can return local_object_size as the return value for the function and exit (block 456).

However, if the class name of the referenced object is not identified in banned list 208, memory profiling agent 200 can further check whether the size of this object has already been measured during the current measurement phase (block 458). if the answer is yes, memory profiling agent 200 can return local_object_size as the return value for the function and exit as per block 456 mentioned above.

If the size of this object has not already been measured, memory profiling agent 200 can enter a loop for each field of the object that is considered a measurement target (block 460). For example, if the passed-in memory reference is associated with a specific list of target fields, agent 200 can loop through each field in that list. Alternatively, if the passed-in memory reference is not associated with a specific list of target fields, agent 200 can loop through every non-static field of the object.

Within the loop of block 460, memory profiling agent 200 can use the Java reflection API to determine whether the current field is a Java primitive data type (e.g., boolean, char, int, short, etc.) or a reference to another object (i.e., sub-object) (block 462). If the current field is a Java primitive data type, memory profiling agent 200 can set local_object_size=(local_object_size+(the size of the primitive data type)) (block 464) and proceed to the end of the current loop iteration.

On the other hand, if the current field is not a Java primitive type (and thus is a reference to a sub-object), memory profiling agent 200 can recursively invoke measureSize with the current field as an input parameter (block 466) and set local_object_size=(local_object_size+(output of the measureSize invocation)) (block 468). Memory profiling agent 200 can then reach the end of the current loop iteration (block 470) and return to the top of the loop to process additional target fields of the object.

Once all of the target fields have been processed, memory profiling agent 200 can return local_object_size as the return value for the function and exit (block 472).

To further clarify the operation of memory profiling agent 200 as described in FIGS. 3 and 4A/4B, assume that the following banned and target lists are included in configuration file 204:

Listing 3

{

“bannedList”: [

{

“className”: “ClassD”

}

],
“targetList”: [

{

“className”: “ClassX”,
“fields”: [

{

“name”: “Field0”

}

]

},
{

“className”: “ClassG”

}

]

}

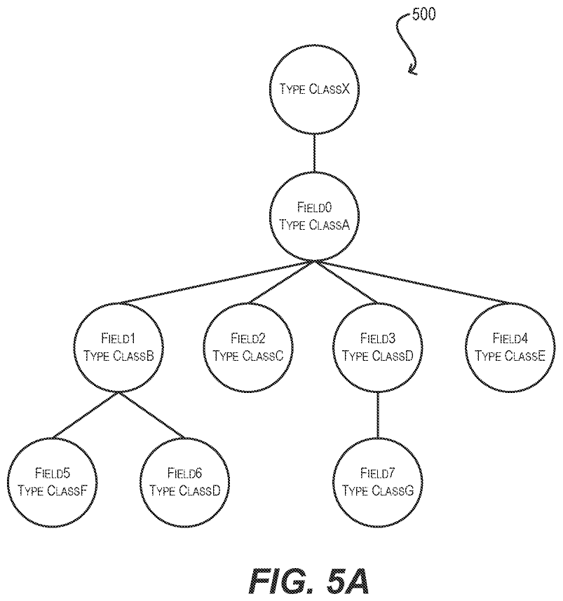

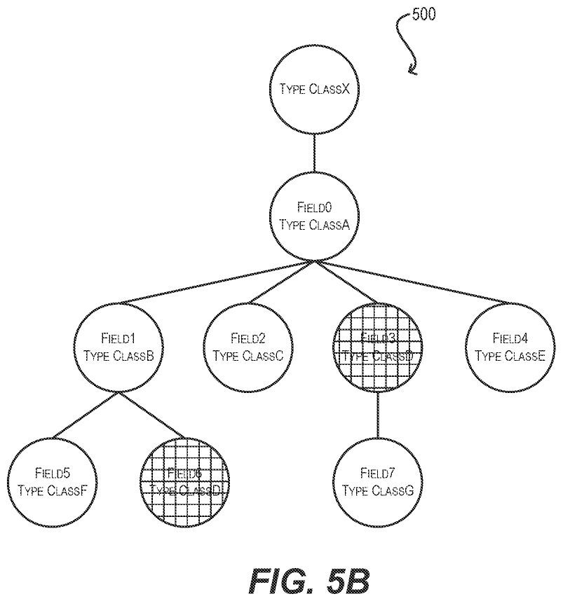

In addition, assume that an instance (i.e., object) 500 of class “Classy” is created during the runtime of Java program 202 as shown in FIG. 5A. In this scenario, memory profiling agent 200 will measure the memory size of Fields of object 500 (corresponding to object type “ClassA”) by taking into account the sizes of sub-fields Field1, Field2, Field4, Field5, and Field 7. Agent 200 will specifically ignore Field3 and Field6 because the type of these objects (i.e., ClassD) is identified in the banned list.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying;, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a general purpose computer system selectively activated or configured by program code stored in the computer system. in particular, various general purpose machines may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments, and are presented to illustrate the flexibility and advantages of particular embodiments as defined by the following claims. Other arrangements, embodiments, implementations and equivalents can be employed without departing from the scope hereof as defined by the claims.

What is claimed is:

1. A method comprising:
detecting, by a Java agent, that a Java Virtual Machine (JVM) is loading a Java class used by a Java program;
determining, by, the Java agent, a class name of the Java class;
determining, by the Java agent, that the class name matches an entry in a first list included in a user-defined configuration file, and
in response to determining that the class name matches the entry, dynamically inserting, by the Java agent, bytecode into a constructor of the Java class, the inserted bytecode including logic for registering a memory reference to an object created via the constructor.

2. The method of claim 1 wherein the first list is a list identifying Java classes of the Java program that are targets for memory measurement.

3. The method of claim 1 wherein the entry in the first list identifies the class name and one or more fields of the Java class,

4. The method of claim 1 further comprising, at a time memory measurement of the Java program is requested:
executing a measurement function with the memory reference to the object as an input parameter;
receiving a measured size of the object as output from the measurement function; and
outputting the measured size to one or more predefined storage locations.

5. The method of claim 4 wherein executing the measurement function comprises;
initializing an object size variable to zero;
determining, via the memory reference, whether the Java class of the object matches an entry in a second list included in the user-defined configuration file; and
if the Java class of the object does match the entry in the second list, returning a value of the object size variable.

6. The method of claim 5 wherein the second list is a list identifying Java classes of the Java program that should be excluded from memory measurement.

7. The method of claim 5 wherein if the Java class of the object does not match the entry in the second list, executing the measurement function further comprises:
for each field of the object:
determining whether the field is a primitive data type or a reference to a sub-object of the object;
if the field is a primitive data type, incrementing the object size variable by a size of the primitive data type; and
if the field is a reference to a sub-object, recursively executing the measurement function with the reference to the sub-object as an input parameter.

8. A non-transitory computer readable storage medium having stored thereon program code executable by a Java agent running on a computer system, the program code embodying a method comprising:
detecting that a Java Virtual Machine (JVM) is loading a Java class used by a Java program;
determining a class name of the Java class;
determining that the class name matches an entry in a first list included in a user-defined configuration file; and
in response to determining that the class name matches the entry, dynamically inserting bytecode into a constructor of the Java class, the inserted bytecode including logic for registering a memory reference to an object created via the constructor.

9. The non-transitory computer readable storage medium of claim 8 wherein the first list is a list identifying Java classes of the Java program that are targets for memory measurement.

10. The non-transitory computer readable storage medium of claim 8 wherein the entry in the first list identifies the class name and one or more fields of the Java class.

11. The non-transitory computer readable storage medium of claim 8 wherein the method further comprises, at a time memory measurement of the Java program is requested:
executing a measurement function with the memory reference to the object as an input parameter;
receiving a measured size of the object as output from the measurement function; and
outputting the measured size to one or more predefined storage locations.

12. The non-transitory computer readable storage medium of claim 11 wherein executing the measurement function comprises;
initializing an object size variable to zero;
determining, via the memory reference, whether the Java class of the object matches an entry in a second list included in the user-defined configuration file; and
if the Java class of the object does match the entry in the second list, returning a value of the object size variable.

13. The non-transitory computer readable storage medium of claim 12 wherein the second list is a list identifying Java classes of the Java program that should be excluded from memory measurement.

14. The non-transitory computer readable storage medium of claim 12 wherein if the Java class of the object does not match the entry in the second list, executing the measurement function further comprises:
for each field of the object:
determining whether the field is a primitive data type or a reference to a sub-object of the object;
if the field is a primitive data type, incrementing the object size variable by a size of the primitive data type; and
if the field is a reference to a sub-object, recursively executing the measurement function with the reference to the sub-object as an input parameter.

15. A computer system comprising:
a processor;
and a non-transitory computer readable medium having stored thereon program code that, when run, causes the processor to:
detect that a Java Virtual Machine (JVM) is loading a Java class used by a Java program;
determine a class name of the Java class;
determine that the class name matches an entry in a first list included in a user-defined configuration file; and
in response to determining that the class name matches the entry, dynamically insert bytecode into a constructor of the Java class, the inserted bytecode including logic for registering a memory reference to an object created via the constructor.

16. The computer system of claim 15 wherein the first list is a list identifying Java classes of the Java program that are targets for memory measurement.

17. The computer system of claim 15 wherein the entry in the first list identifies the class name and one or more fields of the Java class.

18. The computer system of claim 15 wherein the program code further causes the processor to, at a time memory measurement of the Java program is requested:
execute a measurement function with the memory reference to the object as an input parameter;
receive a measured size of the object as output from the measurement function; and
output the measured size to one or more predefined storage locations.

19. The computer system of claim 18 wherein executing the measurement function comprises:
initializing an object size variable to zero;
determining, via the memory reference, whether the Java class of the object matches an entry in a second list included in the user-defined configuration file; and
if the Java class of the object does match the entry in the second list, returning a value of the object size variable.

20. The computer system of claim 19 wherein the second list is a list identifying Java classes of the Java program that should be excluded from memory measurement.

21. The computer system of claim 19 wherein if the Java class of the object does not match the entry in the second list, executing the measurement function further comprises:
for each field of the object:
determining whether the field is a primitive data type or a reference to a sub-object of the object;
if the field is a primitive data type, incrementing the object size variable by a size of the primitive data type; and
if the field is a reference to a sub-object, recursively executing the measurement function with the reference to the sub-object as an input parameter.
